(19) United States
(12) Patent Application Publication
(10) Pub. No.: US 2005/0205620 A1
(43) Pub. Date: Sep. 22, 2005

(54) Shoulder belt, and baby band with the shoulder belt

(75) Inventor: Makoto Yagisawa, Tokyo (JP)

Correspondence Address: WITHROW & TERRANOVA, P.L.L.C., P.O. BOX 1287, CARY, NC, 27512, US

(73) Assignee: Nihon Eightex Kabushiki Kaisha, Tokyo (JP)

(21) Appl. No.: 10/518,247

(22) PCT Filed: Nov. 21, 2003
(86) PCT No.: PCT/JP03/14874

§ 371 Date: Dec. 16, 2004

(30) Foreign Application Priority Data
Jul. 29, 2003 (JP) 2003-270268
Sep. 30, 2003 (JP) 2003-340204

(51) Int. Cl. A45F 3/12; A41F 15/02; A61G 1/00

(52) U.S. Cl. 224/159; 224/264

(57) ABSTRACT

In the shoulder belt to be hung from one shoulder to a waist opposite to the shoulder, tip portions of a pair of shoulder belt parts, which are located in front and back of a human body respectively, are connected through two connecting belts which are overlapped each other such that longitudinal central portions are separated laterally. The two connecting belts constitute a shoulder locking belt portion to be hung on an upper surface of a shoulder and an upper arm locking belt portion to be hung on an outer surface of a upper arm in a vicinity of a shoulder joint, and are hung on the upper surface of the shoulder and the outer surface of the upper arm, thereby distributing the load applied to the shoulder belt.

### TECHNICAL FIELD

The present invention relates to a shoulder belt provided in a baby carrier, a bag, or the like, and more specifically, it relates to a shoulder belt to be obliquely hung on a shoulder (in a sash type) for use.

### BACKGROUND ART

In conventional shoulder belts to be obliquely hung on a shoulder for use, it had been generally known that a pad was sewed onto or movably inserted into a portion corresponding to a shoulder of a user (for example, see Japanese Unexamined Patent Application Publication No. 2001-078857).

Further, it had been suggested a shoulder belt in which a large-width fabric was hung from an upper surface of the shoulder to an outer surface of an upper arm (for example, see Japanese Utility Model Registration Publication No. 3083231).

In the shoulder belt disclosed in Japanese Unexamined Patent Application Publication No. 2001-078857, however, contact of the shoulder belt to the upper surface of the shoulder can be mitigated, but load (weight of an infant in a baby carrier or weight of a bag including weight of the contents in the bag) supported by the shoulder belt acts intensively to a portion of the shoulder on which the shoulder belt is hung. As a result, there was a problem in that the user suffered pains.

Further, the large-width shoulder fabric disclosed in Japanese Utility Model Registration Publication No. 3083231 is hung surely from the upper surface of the shoulder to the outer surface of the upper arm astride a shoulder joint, but since the shoulder fabric is smooth, a shoulder string is hung on the shoulder joint. In addition, since the shoulder string is made of one sheet, there is a disadvantage in that the fabric hung on the shoulder joint may slide toward the upper surface of the shoulder or the outer surface of the upper arm and thus may slip from the shoulder. Furthermore, since the load acts intensively on the shoulder, similarly to Japanese Unexamined Patent Application Publication No. 2001-078857, there is also a disadvantage that the user suffers pains.

The present invention is made to solve the above problems and it is an object of the present invention to provide a shoulder belt which can be used agreeably without giving pains by preventing load from acting intensively.

Further, it is another object of the present invention to provide a shoulder belt which can be stably hung on a shoulder without slipping.

Furthermore, it is still another object of the present invention to provide a baby carrier which can be used agreeably without giving pains.

### DISCLOSURE OF THE INVENTION

In order to accomplish the above objects, there is provided a shoulder belt to be obliquely hung on a shoulder, the shoulder belt comprising a shoulder locking belt portion to be hung on the upper surface of the shoulder and an upper arm locking belt portion to be hung on an outer surface of an upper arm in a vicinity of a shoulder joint, wherein the shoulder locking belt portion and the upper arm locking belt portion are disposed in an intermediate portion of the shoulder belt and surround the shoulder joint.

The shoulder locking belt portion and the upper arm locking belt portion of the shoulder belt may be made of two belts.

More specifically, the shoulder locking belt portion and the upper arm locking belt portion may be formed by connecting two connecting belts, in which tip portions of a pair of shoulder belt parts overlap each other, and longitudinal central portions are laterally (belt width direction) separated (opened) from each other.

The connecting belts may be formed in an outward convex shape and in a sack shape and on an inner part of which a pad may be provided.

In another aspect of the structure using two belts, the shoulder locking belt portion and the upper arm locking belt portion are made by sewing an auxiliary belt onto one shoulder belt part, in which the auxiliary belt disposed corresponding to a portion of the shoulder belt part to be hung on the shoulder are overlapped at least on both ends of the shoulder belt part, and both ends of the auxiliary belt are sewed onto the shoulder belt part such that longitudinal central portions are laterally (belt width direction) separated (opened). That is, both ends of the auxiliary belt are sewed onto one shoulder belt part in a bypass manner.

The shoulder locking belt portion and the upper arm locking belt portion in the shoulder belt may be made of one belt.

That is, the shoulder locking belt portion and the upper arm locking belt portion may be made by forming a slit or a opening at a relevant position of a belt to be hung on the shoulder along a longitudinal direction of the belt and dividing the belt into two portions in the width direction of the belt. Further, in this case, the whole shoulder belt may be made of one belt, or tip portions of a pair of shoulder belt parts may be connected to the two divided shoulder belt.

The shoulder locking belt portion and the upper arm locking belt portion are laterally separated (opened) and are hung on the upper surface of the shoulder and the outer surface of the upper arm, in which the opening quantity may be adjustable.

More specifically, for example, inner edges in the width direction of the shoulder locking belt portion and the upper arm locking belt portion are connected by a stopper attached fastener and the position of the stopper are changed, whereby the opening quantity of the fastener may be adjusted. Alternatively, the opening quantity may be adjusted by providing stopping members at a predetermined interval along the inner edges in the width direction of the shoulder locking belt portion and the upper arm locking belt portion and changing the locking position of the stopping members.

In addition, the shoulder belt may be used in a bag, a baby carrier, etc.

### BRIEF DESCRIPTION OF THE DRAWINGS

FIG. 1 is a partial plan view showing a shoulder belt according to a first embodiment of the present invention.

FIG. 2 is a partial front view showing the shoulder belt.

FIG. 3 is an enlarged cross-sectional view taken along line A-A of FIG. 1.

FIG. 4 is a perspective view showing a baby carrier to which the shoulder belt is applied.

FIG. 5 is a perspective view showing usage of the baby carrier of which the shoulder belt is hung on a left shoulder.

FIG. 6 is a perspective view showing usage of the baby carrier of which the shoulder belt is hung on a right shoulder.

FIG. 7 is a perspective view showing usage of a shoulder belt according to a second embodiment of the present invention.

FIG. 8 is a partial plan view showing of the shoulder belt.

FIG. 9 is a partial plan view showing an example of opening quantity adjusting means.

FIG. 10 is a partial plan view showing another example of the opening-quantity adjusting means.

### BEST MODE FOR CARRYING OUT THE INVENTION

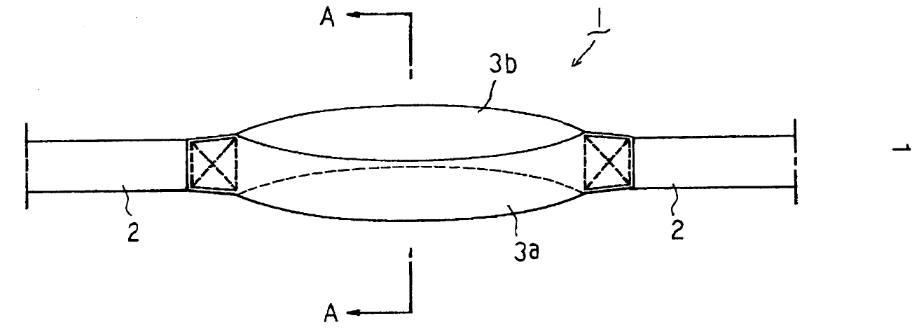

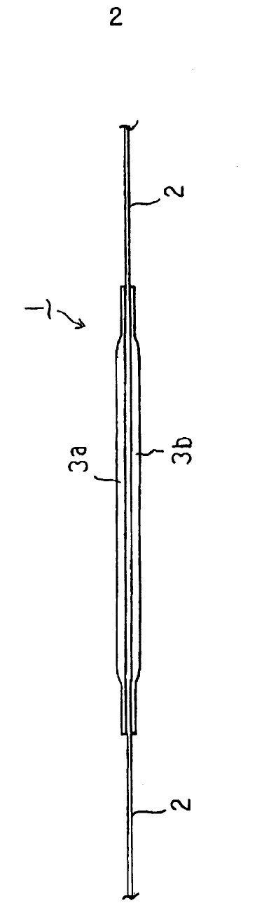

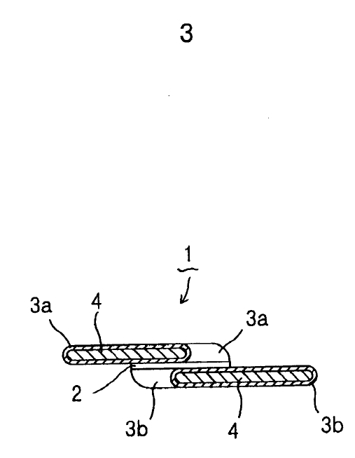

Next, a preferred embodiment in which the present invention is applied to a baby carrier will be described in detail with reference to FIGS. 1 to 6.

As shown in FIGS. 1 to 3, a shoulder belt 1 is made by overlapping both tips of a connecting belt (shoulder locking belt portion) 3a to be hung on an upper surface of a shoulder in a vicinity of a shoulder joint of a user and both tips of a connecting belt (upper arm locking belt portion) 3b to be hung on an outer surface of an upper arm in a vicinity of the shoulder joint of the user on tips of a pair of shoulder belt parts 2 respectively and sewing the overlapped portions.

As shown in FIGS. 1 to 3, each of the connecting belts 3a, 3b has a convex planar shape and a flat sack shape, into an inner part of which a pad 4 is inserted. Further, in each of the connecting belts 3a, 3b, an edge of a protrusion having a convex shape becomes an outer edge, and the connecting belt moves laterally at least at a central portion. Subsequently, after both ends of the connecting belt 3a are overlapped on an upper surface side of the tip of each of the shoulder belt parts 2 and both ends of the connecting belt 3b are overlapped on a lower surface side of the tip of each of the shoulder belt parts 2, and then the connecting belts 3a and 3b are sewed on the shoulder belt parts 2 respectively.

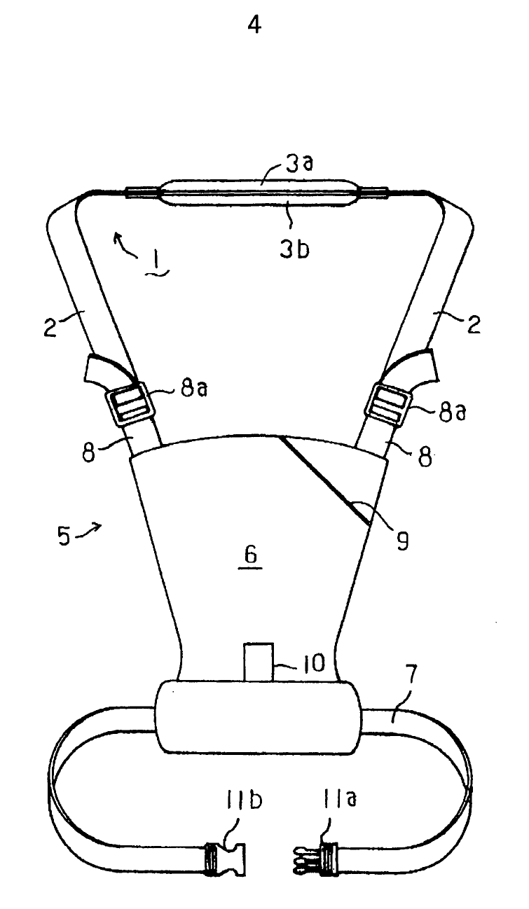

As shown in FIG. 4, the baby carrier to which the shoulder belt 1 is applied includes a back support portion 6 in contact with hips, a waist, and a back of a seated infant, a waist belt 7, which is provided at a lower edge of the back support portion 6 and is wound around the waist of the user, for fixing the lower edge of the back support portion 6 to the user, a pair of connecting bands 8, each comprising a connecting member 8a having a base end sewed respectively onto both ends of an upper edge of the back support portion 6 and connected detachably and length-adjustably to both ends of the shoulder belt 1. In FIG. 4, a reference numeral 9 represents a pocket slot, a reference numeral 10 represents a stopping ring band for suspending baggage, etc., a reference numeral 11a represents a male engaging and disengaging member provided at both tips of the waist belt 7, and a reference numeral 11b represents a female engaging and disengaging member to be attached to and removed from the male engaging and disengaging member 11a.

Referring to FIG. 5, the usage of the baby carrier 5 in which a user hangs the shoulder belt 1 on his left shoulder and carries an infant will be described. To begin with, the user connects both tips of the shoulder belt 1 to the tips of the connecting bands 8 of the back support portion 6 such that the connecting belt 3a is positioned at a left shoulder side, winds the waist belt 7 around his waist, and hangs the shoulder belt 1 on his left shoulder. Subsequently, the user stabilizes an infant by laying the infant on the back support portion 6 and adjusting the length of the shoulder belt 1 by the connecting member 8a, and hangs the connecting belts 3a and 3b on a shoulder side and a upper arm side in a vicinity of the shoulder joint such that a shoulder joint end is surrounded by the connecting belts 3 of the shoulder belt 1. When embracing the infant in this way, the connecting belts 3a and 3b are hung on the shoulder and the upper arm, so that the load is distributed and does not act intensively on the shoulder. In addition, it is possible to prevent the shoulder belt 1 from slipping.

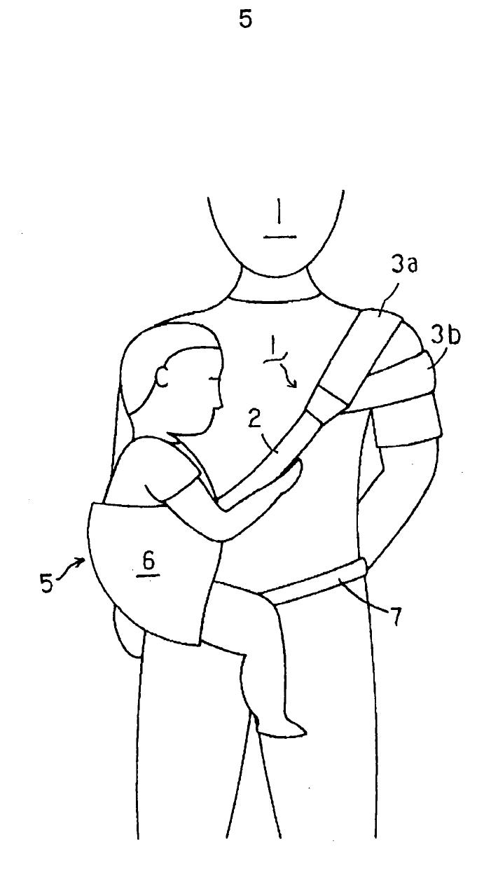

Referring to FIG. 6, the usage of the baby carrier 5 in which the user hangs the shoulder belt 1 on his right shoulder (opposite shoulder to that of FIG. 5) and carries the infant will be described. The user connects both tips of the shoulder belt 1 to the tips of the connecting bands 8 such that the connecting belt 3a is positioned at a right shoulder side, that is, reversely to the case of being hung on the left shoulder. Thereafter, in the same way as the case of FIG. 5, except that the left and the right are inverted, the user embraces the infant. Moreover, the present invention is not limited to the above embodiment. For example, in the present invention, the shoulder belt may be made by using any one of the connecting belts 3a and 3b as one shoulder belt part 2 and sewing both ends of the other one of the connecting belts 3a and 3b, which is an auxiliary belt, onto the shoulder belt part 2 in a state in which the auxiliary belt are overlapped with the shoulder belt part 2 at least at both ends and the central portions are laterally separated from each other, where the auxiliary belt is arranged corresponding to a portion of the shoulder belt part 2 to be hung on the shoulder of the user.

In the above embodiment, the shoulder locking belt portion and the upper arm locking belt portion have been made of two connecting belts 3a and 3b, but they may be made of one belt. Hereinafter, the structure will be described with reference to the drawings.

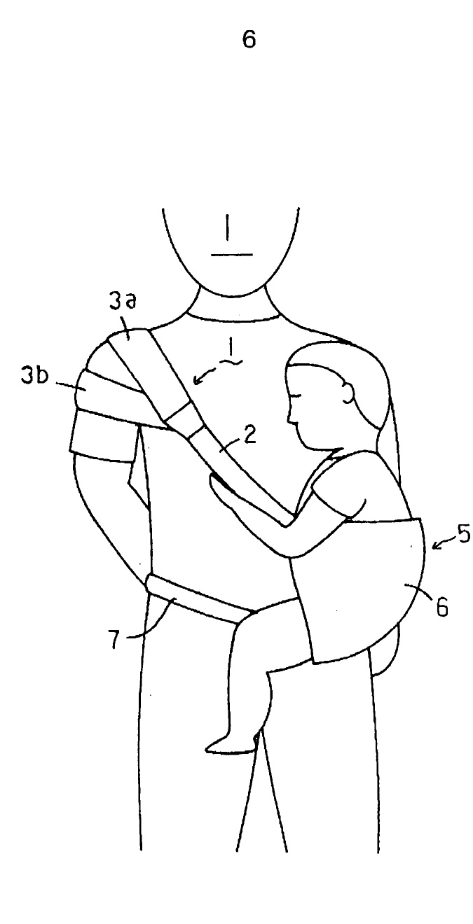

FIG. 7 is an exterior view showing a basic structure of a shoulder belt, in which at the intermediate portion of the shoulder belt 12 with a predetermined length extending in a sash type from one shoulder to a waist of the opposite side, a shoulder locking belt portion 12a to be hung on the upper surface of the shoulder and an upper arm locking belt portion 12b to be hung on the outer surface of the upper arm in a vicinity of a shoulder joint S are dividedly formed, and they surround the shoulder joint.

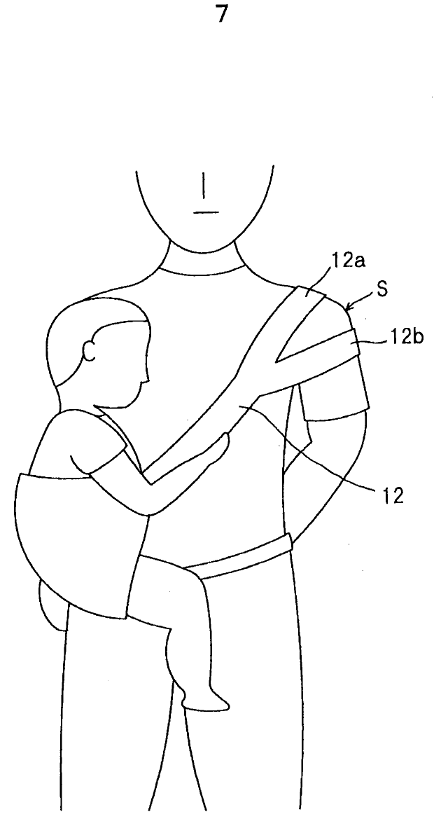

In a specific construction in which the shoulder locking belt portion 12a and the upper arm locking belt portion 12b are made of one belt, as shown in FIG. 8, a predetermined range of the shoulder belt 12 are divided into two portions by forming longitudinally a slit or opening 13 with a predetermined length at the substantially central position of the belt width in a position of the shoulder belt 12 to be hung on the shoulder. One of the two divided belt serves as the shoulder locking belt portion 12a and the other one serves as the upper arm locking belt portion 12b.

In this case, since one belt is divided into two belt portions by the slit or opening 13, if a width of the divided portions of the belt is the same as that of the other portion of the belt, a width of each divided belt is a half of the width of the belt. Therefore, when the width of the shoulder locking belt portion 12a and the upper arm locking belt portion 12b which are dividedly formed is set to be approximately equal to the width of the other portion of the belt, it is preferable to secure the width of the relevant belt portion widely in advance for cutting.

The length of the slit or opening 13 formed in the longitudinal direction of the belt is set to such a length that when the belts divided into two portions by the slit or opening 13 are opened, one (shoulder locking belt portion 12a) of the belts is surely locked on the upper surface of the shoulder and the other one (upper arm locking belt portion 12b) is surely locked on the outer surface of the upper arm.

Meanwhile, figures of users are different from each other. In this case, if the opening quantity divided by the slit or opening 13 is constant, for any user, the opening quantity may be small, and thus it is impossible to lock surely the shoulder belt on the upper surface of the shoulder and the outer surface of the upper arm. Further, for other user, the opening quantity may be large, and thus locking positions on the upper surface of the shoulder and the outer surface of the upper arm may be deviated, so that it is impossible to lock surely. In order to solve the problems, the opening quantity between the belts divided by the slit or passage 13 may be adjustable.

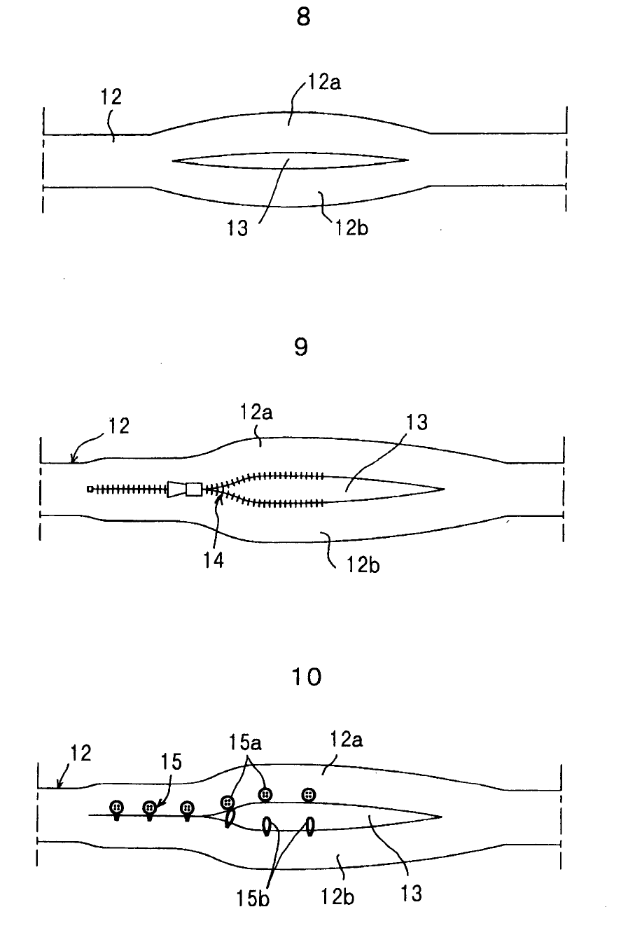

As the adjusting means, as shown in FIG. 9, by connecting inner edges in the width direction of the shoulder locking belt portion and the upper arm locking belt portion by a stopper-attached fastener 14 and changing the position of the stopper, the opening quantity of the fastener may be adjusted.

Alternatively, as shown in FIG. 10, the opening quantity may be adjusted by providing stopping members 15, which comprise buttons 15a and stopping rings 15b arranged oppositely, at a predetermined interval along the inner edges in the width direction of the shoulder locking belt portion and the upper arm locking belt portion and changing the fastening positions of the stopping rings 15b to the buttons 15a. In a case where the opening quantity is adjustable, it is preferable to set the opening quantity to maximum by the slit or opening in advance and then allows a user optimally to adjust the opening quantity by the adjusting means.

In the shoulder belt having the shoulder locking belt portion and the upper arm locking belt portion which are divided by forming the slit or passage 13 in one belt, both ends may be connected to the shoulder belt parts shown in the above embodiment. Of course, the belt portions and the shoulder belt parts may be made of one belt.

### INDUSTRIAL AVAILABILITY

The shoulder belt according to the present invention is not limited to the baby carrier, but may be effectively applied to a bag, etc., only if the shoulder belt 1 is hung obliquely on a shoulder.

1. A shoulder belt to be obliquely hung on one shoulder, the shoulder belt comprising:
a shoulder locking belt portion to be hung on an upper surface of the shoulder; and
an upper arm locking belt portion to be hung on an outer surface of an upper arm in a vicinity of a shoulder joint,
wherein the shoulder locking belt portion and the upper arm locking belt portion are disposed in an intermediate portion of the shoulder belt and surrounds the shoulder joint.

2. The shoulder belt according to claim 1, wherein the shoulder locking belt portion and the upper arm locking belt portion are formed by connecting two connecting belts, in which tip portions of a pair of shoulder belt parts overlap each other, and longitudinal central portions are laterally separated from each other.

3. The shoulder belt according to claim 2, wherein the connecting belts are formed in an outward convex shape and in a sack shape, and on an inner part of which a pad is provided.

4. The shoulder belt according to claim 1, wherein the shoulder locking belt portion and the upper arm locking belt portion are formed by sewing an auxiliary belt onto one shoulder belt part, in which the auxiliary belt disposed corresponding to a portion of the shoulder belt part to be hung on the shoulder are overlapped at least on both ends of the shoulder belt part, and both ends of the auxiliary belt are sewed onto the shoulder belt part such that longitudinal central portions are opened in a belt-width direction.

5. The shoulder belt according to claim 1, wherein the shoulder locking belt portion and the upper arm locking belt portion are made by forming a slit or on opening in a longitudinal direction at a relevant position of the belt in the longitudinal direction of the belt and dividing the belt into two portions in the width direction of the belt.

6. The shoulder belt according to claim 5, wherein an opening quantity between the shoulder locking belt portion and the upper arm locking belt portion are adjustable.

7. A baby carrier having the shoulder belt according to claim 1.
